(19) United States
(12) Patent Application Publication
(10) Pub. No.: US 2021/0041776 A1
(43) Pub. Date: Feb. 11, 2021

(54) LIGHTING SYSTEM AND PROJECTION DEVICE

(71) Applicant: Coretronic Corporation, Hsin-Chu (TW)

(72) Inventors: Chih-Hsien Tsai, Hsin-Chu (TW); Mei-Chun Shih, Hsin-Chu (TW)

(73) Assignee: Coretronic Corporation, Hsin-Chu (TW)

(21) Appl. No.: 16/935,216

(22) Filed: Jul. 22, 2020

(30) Foreign Application Priority Data
Aug. 8, 2019 (CN) 201910729074.1

(51) Int. Cl. G03B 21/20; G03B 33/12

(52) U.S. Cl. CPC G03B 21/204; G03B 33/12; G03B 21/2013

(57) ABSTRACT

The present invention provides a lighting system and a projection device. The lighting system includes a first laser source module providing a first laser beam, a second laser source module providing second and third laser beams, a wavelength conversion module, first and second light splitting units. The first laser beam, the second and third laser beams are respectively emitted from the first and second laser source modules along a first direction. The first laser beam is converted into an excited beam by the wavelength conversion module. The first and second light splitting units are substantially non-parallel, and the excited beam, the second and third laser beams form a lighting beam by one of the first and second light splitting units. The lighting system and the projection device provided by the present invention are small in size and simple in optical path design.

### CROSS-REFERENCE TO RELATED APPLICATION

This application claims the priority benefit of China application serial no. 201910729074.1, filed on Aug. 8, 2019. The entirety of the above-mentioned patent application is hereby incorporated by reference herein and made a part of this specification.

### BACKGROUND

### Technical Field

The present invention relates to an optical system and an optical device including the same, and in particular, to a lighting system and a projection device.

### Description of Related Art

In recent years, a projection device mainly comprising solid-state light sources such as a light-emitting diode (LED) and a laser diode has gradually occupied a place in the market. Generally speaking, excitation lights of the solid-state light sources are converted by a wavelength conversion material on a wavelength conversion module in the projection device to generate converted lights with different colors. In order to meet the demand of color performance, a light filtering module is placed on a rear-section optical path of the projection device, and a preset color light is filtered after the converted light from the wavelength conversion module passes through the light filtering module. An image beam is projected to the outside by modulating the color lights using a light valve.

No red phosphors which are high in conversion rate and heat-resistant have been provided at present, and therefore, the known method in which the projection device adopting the laser diode generates a red/green light to relatively conform to the cost is to excite a region containing a green or yellow phosphor in the wavelength conversion module to generate a yellow/green light by using a blue light laser diode. In addition, a wavelength conversion region containing the green phosphor corresponds to a green light filtering region of the light filtering module, so that a green converted light is filtered to conform to an expected green light; and a wavelength conversion region containing the yellow phosphor corresponds to a red and yellow light filtering region of the light filtering module, so that a yellow converted light is respectively filtered to conform to expected red and yellow lights.

However, a short-wavelength blue light source for exciting a phosphor and a long-wavelength blue light source for providing a blue light are required to simultaneously exist in the design of an optical path of the projection device, and the blue light with a long wavelength does not need to pass through the wavelength conversion module, so that the short-wavelength blue light source and the long-wavelength blue light source are located on different optical paths, and thus, the overall device needs a relatively large volume to provide a space required by the design of the optical path.

In addition, it is already known that there is another way in which the performance of the red light is acquired or improved in a way of additionally providing a secondary light source. However, for the design of the optical path, the secondary light source needs to be mixed with an excited light of the wavelength conversion module by virtue of the configuration of a color separation component and is generally arranged together with the blue light source in a way of conjugated arrangement relative to the color separation component, and the secondary light source and the blue light source are also located on different optical paths, so that the overall device still needs a relatively large volume to provide the space required by the design of the optical path.

The information disclosed in this Background section is only for enhancement of understanding of the background of the described technology and therefore it may contain information that does not form the prior art that is already known to a person of ordinary skill in the art. Further, the information disclosed in the Background section does not mean that one or more problems to be resolved by one or more embodiments of the invention was acknowledged by a person of ordinary skill in the art.

### SUMMARY

The present invention provides a lighting system which is small in size and simple in optical path design.

The present invention provides a projection device which is small in size and simple in optical path design.

Other objectives and advantages of the present invention are further known from technical characteristics disclosed by the present invention.

In order to achieve one, a part or all of the objectives or other objectives, an embodiment of the present invention provides a lighting system. The lighting system includes a first laser source module, a second laser source module, a wavelength conversion module, a first light splitting unit and a second light splitting unit. The first laser source module is used for providing a first laser beam, wherein the first laser beam is emitted from the first laser source module in a first direction. The second laser source module is used for providing a second laser beam and a third laser beam, wherein the second laser beam and the third laser beam are emitted from the second laser source module in the first direction. The wavelength conversion module is located on a transfer path of the first laser beam. The first light splitting unit is located on the transfer path of the first laser beam, wherein the first laser beam is transferred to the wavelength conversion module by the first light splitting unit and is converted into an excited beam by the wavelength conversion module. The second light splitting unit is located on a transfer path of the second laser beam and the third laser beam, wherein the first light splitting unit and the second light splitting unit are substantially non-parallel, and the excited beam, the second laser beam and the third laser beam form a lighting beam by one of the first light splitting unit and the second light splitting unit.

In order to achieve one, a part or all of the objectives or other objectives, an embodiment of the present invention provides a projection device. The projection device includes the lighting system, a light valve and a projection lens. The lighting system is used for providing a lighting beam. The light valve is arranged on a transfer path of the lighting beam and is used for converting the lighting beam into an image beam. The projection lens is arranged on a transfer path of the image beam and is used for projecting the image beam out of the projection device.

Based on the above, the embodiment of the present invention at least has one of the following advantages or effects. In the embodiment of the present invention, due to the design of an optical path that the first laser beam, the second laser beam and the third laser beam are respectively emitted from the first laser source module and the second laser source module in the same direction in the projection device and the lighting system, the first laser source module and the second laser source module are arranged on the same plane, and thus, the projection device and the lighting system achieve small size and simple optical path design. In addition, due to the substantial non-parallel arrangement of the first light splitting unit and the second light splitting unit in the projection device and the lighting system, the light collecting efficiency of the excited beam, the second laser beam and the third laser beam achieves good performance, and furthermore, the lighting beam has good color performance.

In order to make the aforementioned and other objectives and advantages of the present invention comprehensible, embodiments accompanied with figures are described in detail below.

### BRIEF DESCRIPTION OF THE DRAWINGS

FIG. 1A is a structural schematic diagram of a projection device according to an embodiment of the present invention.

FIG. 1B is a top view of a configuration relationship between a first laser source module and a second laser source module in FIG. 1A.

FIG. 1C is a top view of a configuration relationship between another first laser source module and another second laser source module according to an embodiment of the present invention.

FIG. 2 is a structural schematic diagram of another lighting system according to an embodiment of the present invention.

FIG. 3 is a structural schematic diagram of yet another lighting system according to an embodiment of the present invention.

FIG. 4 is a structural schematic diagram of yet another lighting system according to an embodiment of the present invention.

FIG. 5A is a structural schematic diagram of yet another lighting system according to an embodiment of the present invention.

FIG. 5B is a top view of a configuration relationship between the first laser source module and the second laser source module in FIG. 5A.

FIG. 6 is a structural schematic diagram of yet another lighting system according to an embodiment of the present invention.

### DESCRIPTION OF THE EMBODIMENTS

Embodiments of the present invention will be illustrated below with the accompanying drawings. The directional terms mentioned in the present invention, like “above”, “below”, “front”, “back”, “left”, and “right”, refer to the directions in the appended drawings. Therefore, the directional terms are only used for illustration instead of limiting the present invention.

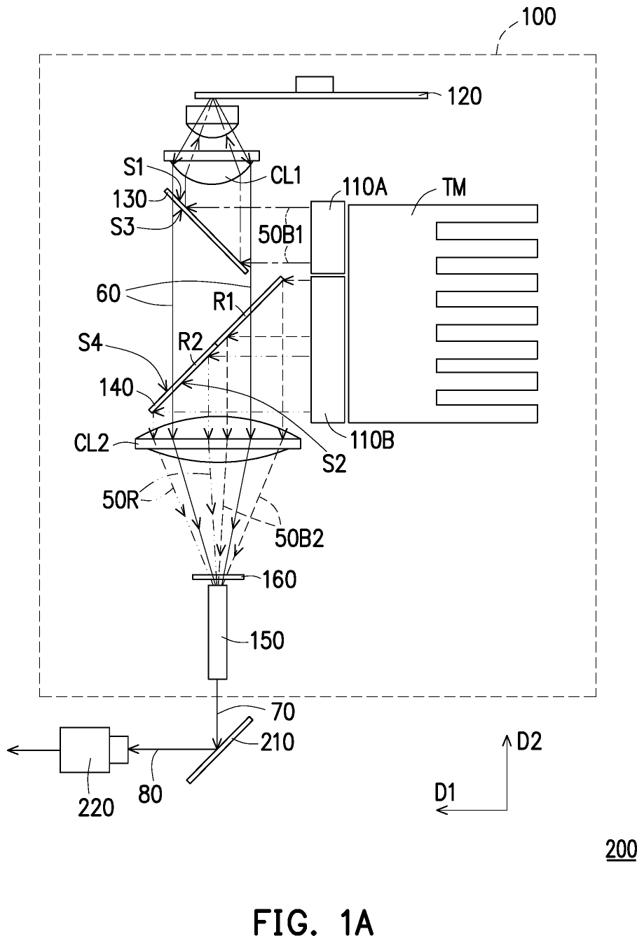

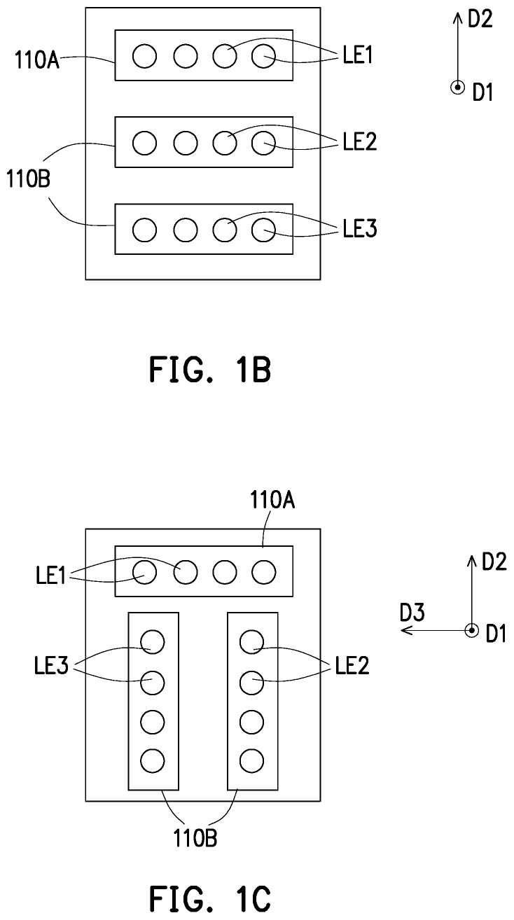

FIG. 1A is a structural schematic diagram of a projection device according to an embodiment of the present invention. FIG. 1B is a top view of a configuration relationship between a first laser source module and a second laser source module in FIG. 1A. Referring to FIG. 1A, a projection device 200 includes a lighting system 100, a light valve 210 and a projection lens 220. The lighting system 100 is used for providing a lighting beam 70. The light valve 210 is arranged on a transfer path of the lighting beam 70 and is used for converting the lighting beam 70 into an image beam 80. The projection lens 220 is arranged on a transfer path of the image beam 80 and is used for projecting the image beam 80 out of the projection device 200. In the present embodiment, one light valve 210 is provided, but the present invention is not limited herein, and in other embodiments, a plurality of the light valve 210 are provided. In addition, in the present embodiment, the light valve 210 is a digital micro-mirror device (DMD) or a liquid-crystal-on-silicon panel (LCOS panel). However, in other embodiments, the light valve 210 is also a transmissive liquid crystal display panel or any other beam modulator. Specifically speaking, as shown in FIG. 1A, in the present embodiment, the lighting system 100 includes a first laser source module 110A, a second laser source module 110B, a heat radiation module TM, a wavelength conversion module 120, a first light splitting unit 130, a second light splitting unit 140, a condensing lens CL1, a condensing lens CL2 and a light homogenization component 150.

Specifically speaking, as shown in FIG. 1A, in the present embodiment, the first laser source module 110A is used for providing a first laser beam 50B1, the second laser source module 110B is used for providing a second laser beam 50B2 and a third laser beam 50R. For example, as shown in FIG. 1B, in the present embodiment, the first laser source module 110A includes at least one first laser component LE1 capable of emitting the first laser beam 50B1. The second laser source module 110B includes at least one second laser component LE2 and at least one third laser component LE3 capable of respectively emitting the second laser beam 50B2 and the third laser beam 50R.

Further, as shown in FIG. 1A, in the present embodiment, the first laser beam 50B1 is emitted from the first laser source module 110A in a first direction D1, while the second laser beam 50B2 and the third laser beam 50R are emitted from the second laser source module 110B in the first direction D1. In other words, in the present embodiment, the first laser beam 50B1, the second laser beam 50B2 and the third laser beam 50R are respectively emitted from the first laser source module 110A and the second laser source module 110B in the same direction. Therefore, in the present embodiment, the first laser source module 110A and the second laser source module 110B are located on the same plane. For example, as shown in FIG. 1A, the first laser source module 110A and the second laser source module 110B are arranged on the surface of the same substrate or any other component (such as the heat radiation module TM). Therefore, the heat radiation module TM is simply arranged. Further, as shown in FIG. 1A, the heat radiation module TM is connected with the first laser source module 110A and the second laser source module 110B so as to be arranged at the backs of the first laser source module 110A and the second laser source module 110B.

On the other hand, as shown in FIG. 1A, in the present embodiment, the first laser beam 50B1 and the second laser beam 50B2 are blue laser beams, and the third laser beam 50R is a red laser beam. For example, as shown in FIG. 1B, in the present embodiment, each of the at least one first laser component LE1 and the at least one second laser component LE2 includes a plurality of blue laser diodes arranged in an array, while the at least one third laser component LE3 includes a plurality of red laser diodes arranged in an array, but the present invention is not limited herein. In other embodiments, the number of each of the first laser component LE1, the second laser component LE2 and the third laser component LE3 is also one as long as the brightness is sufficient.

In addition, in the present embodiment, although both the first laser beam 50B1 and the second laser beam 50B2 are the blue laser beams, the dominant wavelength of the first laser beam 50B1 is smaller than that of the second laser beam 50B2. In other words, in the present embodiment, the first laser beam 50B1 and the second laser beam 50B2 are lights with the same color and different spectrums, wherein the first laser beam 50B1 with a relatively short wavelength is relatively easily converted into an excited beam 60 by the wavelength conversion module 120 to form a green light part of the lighting beam 70, while the second laser beam 50B2 with a long wavelength is favorably felt by eyes of people, and therefore, the second laser beam 50B2 is used for forming a blue light part of the lighting beam 70 to ensure that the lighting beam 70 has good color performance.

On the other hand, the third laser beam 50R is the red laser beam, and therefore, the dominant wavelength of the third laser beam 50R is also different from the dominant wavelengths of the first laser beam 50B1 and the second laser beam 50B2, while the dominant wavelength of the first laser beam 50B1 is smaller than the dominant wavelengths of the second laser beam 50B2 and the third laser beam 50R. For example, the difference of the dominant wavelength of the second laser beam 50B2 and the dominant wavelength of the third laser beam 50R is larger than 50 nm. Therefore, the third laser beam 50R is used for forming a red light part of the lighting beam 70 to also ensure that the lighting beam 70 has good color performance.

The process that the first laser beam 50B1, the second laser beam 50B2 and the third laser beam 50R form the lighting beam 70 will be further described below.

Specifically speaking, as shown in FIG. 1A, in the present embodiment, the first light splitting unit 130 is located on a transfer path of the first laser beam 50B1 and is arranged to correspond to the first laser source module 110A. The first light splitting unit 130 is provided with a first surface 51 and a third surface S3 which are opposite to each other, and the first surface 51 faces the first laser source module 110A and the wavelength conversion module 120. For example, in the present embodiment, the first light splitting unit 130 is, for example, a dichroic mirror capable of providing an effect on reflecting a blue beam to allow beams with other colors (such as red, green and yellow) to penetrate. In other words, as shown in FIG. 1A, in the present embodiment, the first light splitting unit 130 is used for reflecting the first laser beam 50B1 and is penetrated by the excited beam 60, and therefore, as shown in FIG. 1A, the first laser beam 50B1 is transferred to the wavelength conversion module 120 by the first light splitting unit 130.

Further, as shown in FIG. 1A, in the present embodiment, the wavelength conversion module 120 is located on the transfer path of the first laser beam 50B1, but is not located on a transfer path of the second laser beam 50B2 and the third laser beam 50R. The wavelength conversion module 120 is provided with an annular wavelength conversion layer (not shown) or a wavelength conversion layer (not shown) set to be C-shaped, and thus, a wavelength conversion region (not shown) is formed on a substrate of the wavelength conversion module 120. As shown in FIG. 1A, in the present embodiment, the first laser beam 50B1 is eccentrically incident into the wavelength conversion module 120 by the condensing lens CL1 and is converted into the excited beam 60 by the wavelength conversion region of the wavelength conversion module 120. In addition, in the present embodiment, the excited beam 60 is a green beam to be capable of penetrating the first light splitting unit 130, and therefore, the excited beam 60 is transferred to the second light splitting unit 140 by the condensing lens CL1 and the first light splitting unit 130.

Specifically speaking, as shown in FIG. 1A, in the present embodiment, the second light splitting unit 140 is located on a transfer path of the first laser beam 50B1, the second laser beam 50B2 and the third laser beam 50R and is arranged to correspond to the second laser source module 110B. The second light splitting unit 140 is provided with a second surface S2 and a fourth surface S4 which are opposite to each other, and the second surface S2 faces the second laser source module 110B and the condensing lens CL2.

Further, as shown in FIG. 1A, the second light splitting unit 140 is provided with a first region R1 and a second region R2 which are not overlapped, the first laser source module 110A and the second laser source module 110B are arranged in a second direction D2, and the second direction D2 is substantially vertical to the first direction D1. As shown in FIG. 1A and FIG. 1B, the second laser component LE2 and the third laser component LE3 are arranged in the second direction D2, and the first region R1 and the second region R2 are arranged in the second direction D2. Therefore, as shown in FIG. 1A, when the second laser beam 50B2 and the third laser beam 50R are emitted from the second laser source module 110B in the first direction D1, the second laser beam 50B2 is correspondingly irradiated on the first region R1, while the third laser beam 50R is correspondingly irradiated on the second region R2.

In addition, for example, in the present embodiment, the second light splitting unit 140 is, for example, a dichroic mirror capable of providing an effect on reflecting the blue beam and a red beam to allow beams with other colors (such as green) to penetrate. In other words, the second light splitting unit 140 is used for reflecting the second laser beam 50B2 with blue color and the third laser beam 50R with red color and allowing the excited beam 60 with green color to penetrate. Known from the above, the first region R1 is set to only reflect blue light, and the second region R2 is set to only reflect red light.

Thus, as shown in FIG. 1A, in the present embodiment, the excited beam 60 is incident into the second light splitting unit 140 by one of the second surface S2 and the fourth surface S4, the second laser beam 50B2 and the third laser beam 50R are incident into the second light splitting unit 140 by the other of the second surface S2 and the fourth surface S4, and the excited beam 60, the second laser beam 50B2 and the third laser beam 50R leave the second light splitting unit 140 in the same direction. More specifically speaking, as shown in FIG. 1A, the excited beam 60 is incident into the second light splitting unit 140 by the fourth surface S4, the second laser beam 50B2 and the third laser beam 50R are incident into the second light splitting unit 140 by the second surface S2, and the excited beam 60, the second laser beam 50B2 and the third laser beam 50R leave the second light splitting unit 140 by the second surface S2 in the same direction. Therefore, as shown in FIG. 1A, the excited beam 60, the second laser beam 50B2 and the third laser beam 50R form the lighting beam 70 by the second light splitting unit 140 and subsequent optical components.

Further, as shown in FIG. 1A, in the present embodiment, the first light splitting unit 130 and the second light splitting unit 140 are substantially non-parallel, and the range of an included angle between the first surface S1 of the first light splitting unit 130 and the second surface S2 of the second light splitting unit 140 is larger than 70° and is smaller than 110°. Therefore, the light collecting efficiency of the excited beam 60, the second laser beam 50B2 and the third laser beam 50R achieves good performance. In addition, the structural arrangement is enabled to be compact, and furthermore, the lighting beam 70 has good color performance.

On the other hand, as shown in FIG. 1A, the condensing lens CL2 and the light homogenization component 150 of the lighting system 100 are located on the transfer path of the excited beam 60, the second laser beam 50B2 and the third laser beam 50R, wherein the second laser beam 50B2 and the third laser beam 50R are respectively incident into the condensing lens CL2 from two sides of a central axis of the condensing lens CL2 after being respectively reflected by the first region R1 and the second region R2 of the second light splitting unit 140. In addition, the excited beam 60 is also symmetrically irradiated on the condensing lens CL2 by taking the optical axis of the condensing lens CL2 as a center. Therefore, the excited beam 60, the second laser beam 50B2 and the third laser beam 50R are uniformly converged on the light homogenization component 150 by the condensing lens CL2. In the present embodiment, the light homogenization component 150 includes an integral column but the present invention is not limited thereto. In more detail, as shown in FIG. 1A, when being transferred to the light homogenization component 150, the excited beam 60, the second laser beam 50B2 and the third laser beam 50R form the lighting beam 70 by the light homogenization component 150 and are transferred to the light valve 210 after being homogenized. The lighting system 100 further includes a light filtering module 160 for increasing the purity of the lighting beam output by the lighting system 100. The light filtering module 160 is arranged on a transfer path of a beam from the condensing lens CL2 and is located between the condensing lens CL2 and the light homogenization component 150. In an embodiment, the light filtering module 160 is a color wheel provided with a plurality of optical regions (not shown) such as a light penetrating region, a green light filtering region and a red light filtering region. The light penetrating region of the light filtering module 160 is used for allowing at least a part of the second laser beam 50B2 (such as the blue beam) to pass through. For example, the light penetrating region T is provided with a blue light filter or a diffusion sheet or no light filter. The green light filtering region of the light filtering module 160 is used for allowing the excited beam 60 (the green beam) to pass through and filtering and removing beams with the rest colors. For example, the green light filtering region is provided with a green light filter. The red light filtering region of the light filtering module 160 is used for allowing the third laser beam 50R (the red beam) to pass through and filtering and removing the beams with the rest colors. For example, the red light filtering region is provided with a red light filter. The light penetrating region, the green light filtering region and the red light filtering region of the light filtering module 160 are sequentially switched on the transfer path of the beam from the condensing lens CL2, so that lighting beams with different colors are sequentially output by the lighting system 100. In another embodiment, the light filtering module 160 is unnecessary, and the lighting beams with the different colors are also sequentially output by the lighting system 100 by controlling the starting time of each of the first laser component LE1, the second laser component LE2 and the third laser component LE3. In other embodiments, the light filtering module 160 is also located behind the light homogenization component 150.

Next, as shown in FIG. 1A, the light valve 210 is located on the transfer path of the lighting beam 70 and is used for forming the image beam 80 from the lighting beam 70. The projection lens 220 is located on the transfer path of the image beam 80 and is used for projecting the image beam 80 so as to project the image beam 80 on a screen (not shown) to form an image picture. The image beams 80 with different colors are sequentially formed from the lighting beam 70 by the light valve 210 and are transferred to the projection lens 220 after the lighting beam 70 is converged on the light valve 210, and therefore, the image picture projected by the image beam 80 converted by the light valve 210 becomes a color picture. In the present embodiment, the number of the light valve 210 is one, and in another embodiment, the light filtering module 160 is also omitted when there are a plurality of the light valves 210, for example, three light valves 210, and the lighting beam 70 is split into the lighting beams with different colors by arranging a light splitting/integrating component (not shown) between the lighting system 100 and the three light valves 210, so that lighting beams with different colors are respectively incident into the three light valves 210 to simultaneously or non-simultaneously form the image beams 80 with the different colors to be transferred to the projection lens 220.

Thus, in the present embodiment, due to the design of an optical path that the first laser beam 50B1, the second laser beam 50B2 and the third laser beam 50R are respectively emitted from the first laser source module 110A and the second laser source module 110B in the same direction in the projection device 200 and the lighting system 100, the first laser source module 110A and the second laser source module 110B are arranged on the same plane, and thus, the projection device 200 and the lighting system 100 achieve a small size and a simple optical path design. In addition, due to the substantial non-parallel arrangement of the first light splitting unit 130 and the second light splitting unit 140 in the projection device 200 and the lighting system 100, the light collecting efficiency of the excited beam 60, the second laser beam 50B2 and the third laser beam 50R achieves good performance, and furthermore, the lighting beam 70 has good color performance.

FIG. 1C is a top view of a configuration relationship between another first laser source module and another second laser source module according to an embodiment of the present invention. It is noteworthy that the second laser component LE2 and the third laser component LE3 are illustrated to be arranged in the second direction D2 in the embodiments in FIG. 1A and FIG. 1B, but the present invention is not limited therein. For example, as shown in FIG. 1C, in another embodiment, the second laser component LE2 and the third laser component LE3 need not to be arranged in the second direction D2, but are arranged in a third direction D3, and the first direction D1, the second direction D2 and the third direction D3 are vertical to one another.

Thus, as shown in FIG. 1C, in the embodiment in FIG. 1C, the first region R1 and the second region R2 of the second light splitting unit 140 are also arranged in the third direction D3, and therefore, when the second laser beam 50B2 and the third laser beam 50R are emitted from the second laser source module 110B in the first direction D1, the second laser beam 50B2 is also correspondingly irradiated on the first region R1, while the third laser beam 50R is also correspondingly irradiated on the second region R2. In other words, the arrangement directions of the second laser component LE2 and the third laser component LE3 are not limited in the present invention, but the second laser component LE2 and the third laser component LE3 are required to correspond to the first region R1 and the second region R2 of the second light splitting unit 140 so that the second laser beam 50B2 and the third laser beam 50R are respectively and correspondingly irradiated on the first region R1 and the second region R2. Thus, when the second laser source module 110B provided with the second laser component LE2 and the third laser component LE3 arranged in the third direction D3 is applied to the lighting system 100 and the projection device 200, the lighting system 100 and the projection device 200 also achieve the above-mentioned effects and advantages, and the descriptions thereof are omitted herein.

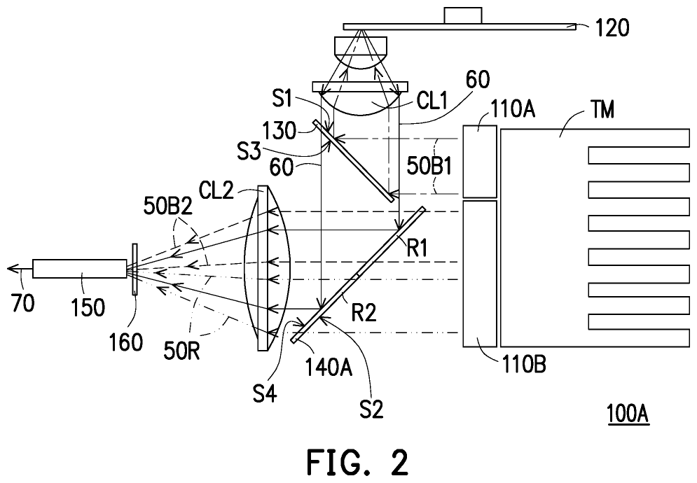

FIG. 2 is a structural schematic diagram of another lighting system according to an embodiment of the present invention. Referring to FIG. 2, a lighting system 100A in FIG. 2 is similar to the lighting system 100 in FIG. 1A, but the difference is described as follows. Specifically speaking, as shown in FIG. 2, in the present embodiment, a second surface S2 of a second light splitting unit 140A of the lighting system 100A faces the second laser source module 110B, a fourth surface S4 faces the condensing lens CL2, and the effect of the second light splitting unit 140A of the lighting system 100A provided for the blue beam, the red beam and the green beam is different from that of the second light splitting unit 140 of the lighting system 100. For example, in the present embodiment, the second light splitting unit 140A is, for example, a dichroic mirror capable of allowing the blue beam and the red beam to penetrate, but providing an effect on reflecting beams with other colors (such as green). In other words, the second light splitting unit 140A is used for being penetrated by the second laser beam 50B2 with blue color and the third laser beam 50R with red color and reflecting the excited beam 60 with green color.

Thus, as shown in FIG. 2, in the present embodiment, the excited beam 60 from the wavelength conversion module 120 is incident into the second light splitting unit 140A by the fourth surface S4, the second laser beam 50B2 and the third laser beam 50R are incident into the second light splitting unit 140A by the second surface S2, and the excited beam 60, the second laser beam 50B2 and the third laser beam 50R are also uniformly converged on the light homogenization component 150 by the condensing lens CL2 to form the lighting beam 70 after leaving the second light splitting unit 140A by the fourth surface S4.

Thus, the configuration relationship among the first laser source module 110A, the second laser source module 110B, the first light splitting unit 130 and the second light splitting unit 140A of the lighting system 100 is similar to that of the first laser source module 110A, the second laser source module 110B, the first light splitting unit 130 and the second light splitting unit 140 of the lighting system 100 in FIG. 1. Therefore, the lighting system 110A also achieves the effects and advantages similar to those of the lighting system 100, and the descriptions thereof are omitted herein. In addition, when the lighting system 100A is applied to the projection device 200 in FIG. 1A, the projection device 200 also achieves the above-mentioned effects and advantages, and the descriptions thereof are omitted herein.

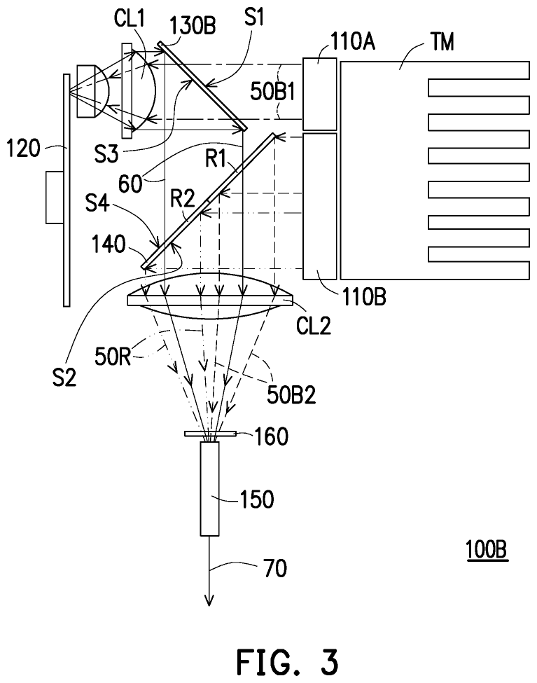

FIG. 3 is a structural schematic diagram of another lighting system according to an embodiment of the present invention. Referring to FIG. 3, a lighting system 100B in FIG. 3 is similar to the lighting system 100 in FIG. 1A, but the difference is described as follows. Specifically speaking, as shown in FIG. 3, in the present embodiment, a first surface 51 of a first light splitting unit 130B of the lighting system 100B faces the first laser source module 110A, a third surface S3 faces the wavelength conversion module 120, and the effect of the first light splitting unit 130B of the lighting system 100B provided for the blue beam and the green beam is different from that of the first light splitting unit 130 of the lighting system 100. For example, in the present embodiment, the first light splitting unit 130B, for example, allows the blue beam to penetrate, but provides an effect on reflecting beams with other colors (such as green). In other words, the first light splitting unit 130B is penetrated by the blue first laser beam 50B1 and is used for reflecting the excited beam 60. Thus, the first laser beam 50B1 is transferred to the wavelength conversion module 120 by the first light splitting unit 130B, and the excited beam 60 from the wavelength conversion module 120 is also transferred to the second light splitting unit 140 by the first light splitting unit 130B.

Then, as shown in FIG. 3, in the present embodiment, the excited beam 60 is incident into the second light splitting unit 140 by the fourth surface S4 of the second light splitting unit 140, the second laser beam 50B2 and the third laser beam 50R are incident into the second light splitting unit 140 by the second surface S2, and the excited beam 60, the second laser beam 50B2 and the third laser beam 50R are also uniformly converged on the light homogenization component 150 by the condensing lens CL2 to form the lighting beam 70 after leaving the second light splitting unit 140 by the second surface S2 of the second light splitting unit 140.

Thus, the configuration relationship among the first laser source module 110A, the second laser source module 110B, the first light splitting unit 130B and the second light splitting unit 140 of the lighting system 110B is similar to that of the first laser source module 110A, the second laser source module 110B, the first light splitting unit 130 and the second light splitting unit 140 of the lighting system 100 in FIG. 1A. Therefore, the lighting system 110B also achieves the effects and advantages similar to those of the lighting system 100, and the descriptions thereof are omitted herein. In addition, when the lighting system 100B is applied to the projection device 200 in FIG. 1A, the projection device 200 also achieves the above-mentioned effects and advantages, the descriptions thereof are omitted herein.

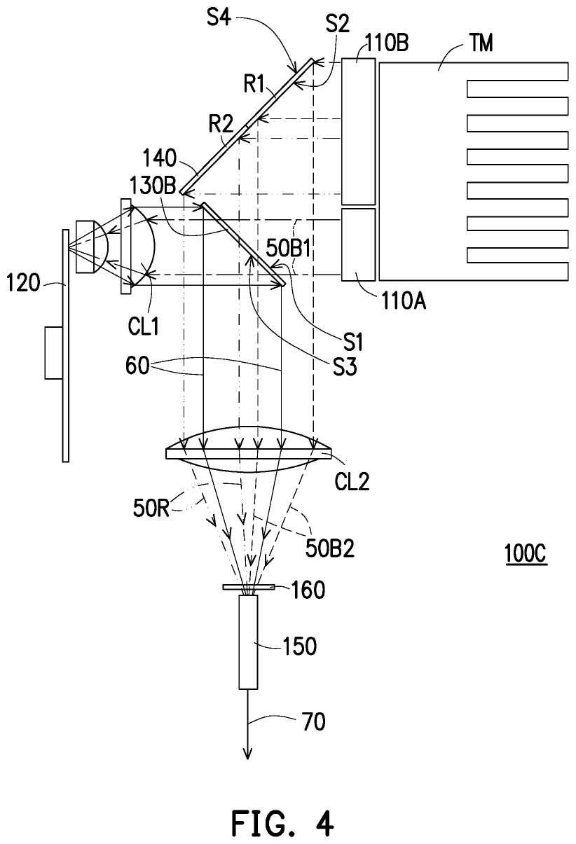

FIG. 4 is a structural schematic diagram of yet another lighting system according to an embodiment of the present invention. Referring to FIG. 4, a lighting system 100C in FIG. 4 is similar to the lighting system 100B in FIG. 3, but the difference is described as follows. Specifically speaking, as shown in FIG. 3, in the embodiment in FIG. 3, an emergent path of the second laser source module 110B (the second light splitting unit 140 corresponding to the second laser source module 110B) is shorter than that of the first laser source module 110A (the first light splitting unit 130B corresponding to the first laser source module 110A). As shown in FIG. 4, in the embodiment in FIG. 4, the emergent path of the second laser source module 110B (the second light splitting unit 140 corresponding to the second laser source module 110B) is longer than that of the first laser source module 110A (the first light splitting unit 130B corresponding to the first laser source module 110A). The emergent path herein means the length of an optical path from a light source module (the first laser source module 110A or the second laser source module 110B) to the light homogenization component 150.

In other words, in the embodiment in FIG. 4, the second laser beam 50B2 and the third laser beam 50R are transferred to the first light splitting unit 130B by the second light splitting unit 140 and form the lighting beam 70 together with the excited beam 60 from the wavelength conversion module 120 by the first light splitting unit 130B and subsequent optical components.

Thus, due to the design of an optical path that the first laser beam 50B1, the second laser beam 50B2 and the third laser beam 50R are respectively emitted from the first laser source module 110A and the second laser source module 110B in the same direction in the lighting system 100C, the first laser source module 110A and the second laser source module 110B are arranged on the same plane, and thus, the lighting system 100C achieves a small size and a simple optical path design. In addition, due to the substantial non-parallel arrangement of the first light splitting unit 130B and the second light splitting unit 140 in the lighting system 100C, the light collecting efficiency of the excited beam 60, the second laser beam 50B2 and the third laser beam 50R achieves good performance, and furthermore, the lighting beam 70 has good color performance. Therefore, the lighting system 100C also achieves the effects and advantages similar to those of the lighting system 100, and the descriptions thereof are omitted herein. In addition, when the lighting system 100C is applied to the projection device 200 in FIG. 1A, the projection device 200 also achieves the above-mentioned effects and advantages, and the descriptions thereof are omitted herein.

It should be explained that, in the embodiment in FIG. 4, one of the second laser beam 50B2 and the third laser beam 50R is set to not pass through the first light splitting unit 130B, namely the first light splitting unit 130B is designed to be relatively short. And the effects of the present invention are also achieved all the same, when all the excited beam 60, the second laser beam 50B2 and the third laser beam 50R are emergent in the same direction behind the first light splitting unit 130B and in front of the condensing lens CL2. Therefore, the scope of the present invention is not limited to that one of the first light splitting unit and the second light splitting unit has to allow three beams with different colors to pass through, the phenomenon that the excited beam 60, the second laser beam 50B2 and the third laser beam 50R are emergent in the same direction between a light splitting unit and the condensing lens belongs to the scope of the present invention.

In another not shown embodiment, the first light splitting unit 130B includes two regions, one of the regions is shown as FIG. 4, and allows lights with other colors to pass through and reflects the excited beam 60, while the other region is a light transmitting region, is made of a material such as glass or plastics and allows one of the second laser beam 50B2 and the third laser beam 50R to pass through.

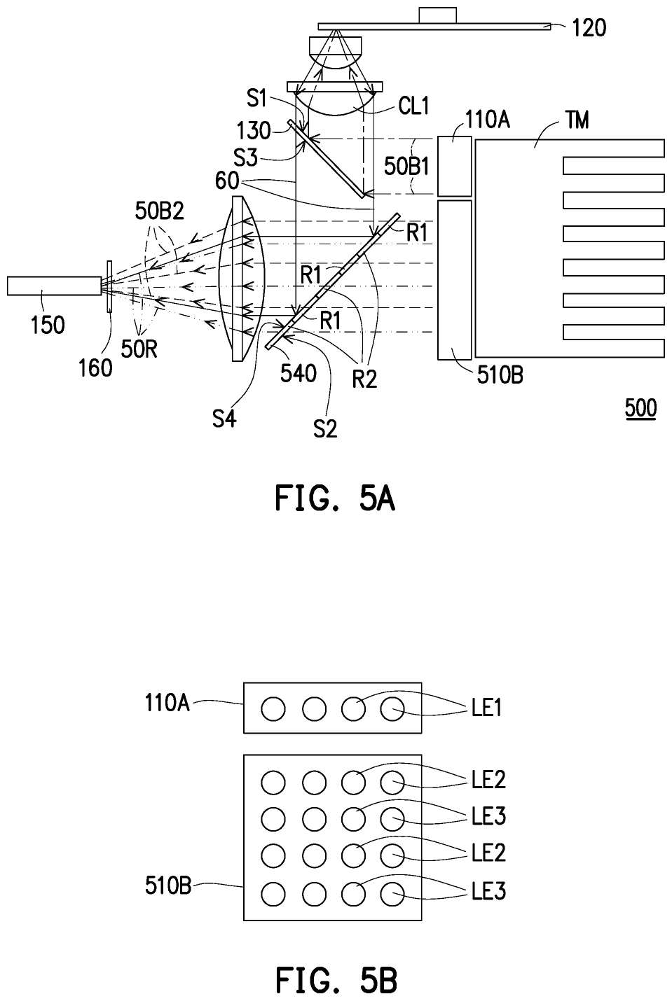

FIG. 5A is a structural schematic diagram of yet another lighting system according to an embodiment of the present invention. FIG. 5B is a top view of a configuration relationship between the first laser source module and the second laser source module in FIG. 5A. Referring to FIG. 5A and FIG. 5B, a lighting system 500 in FIG. 5A is similar to the lighting system 100A in FIG. 2, but the difference is described as follows. Specifically speaking, as shown in FIG. 5A and FIG. 5B, in the present embodiment, the plurality of second laser components LE2 and the plurality of third laser components LE3 are staggered, the effect of a second light splitting unit 540 provided for beams with various colors is the same as that of the second light splitting unit 140A in FIG. 2 provided for the beams with various colors, but the second light splitting unit 540 is provided with a plurality of first regions R1 and a plurality of second regions R2, wherein one of the first regions R1 are located between two of the second regions R2. In other words, as shown in FIG. 5A, in the present embodiment, the second laser beam 50B2 and the third laser beam 50R are respectively irradiated on the plurality of first regions R1 and the plurality of second regions R2 of the second light splitting unit 540 in a staggered way. Thus, the second laser beam 50B2 and the third laser beam 50R more uniformly pass through the second light splitting unit 540 and are incident into the condensing lens CL2. In addition, as shown in FIG. 5A, the excited beam 60, the second laser beam 50B2 and the third laser beam 50R are also converged on the light homogenization component 150 by the second light splitting unit 540 and the condensing lens CL2 to form the lighting beam 70.

Thus, the configuration relationship among the first laser source module 110A, the second laser source module 110B, the first light splitting unit 130 and the second light splitting unit 540 of the lighting system 500 is similar to that of the first laser source module 110A, the second laser source module 110B, the first light splitting unit 130 and the second light splitting unit 140A of the lighting system 100A in FIG. 2. Therefore, the lighting system 500 also achieves the effects and advantages similar to those of the lighting system 100A, and the descriptions thereof are omitted herein. In addition, when the lighting system 500 is applied to the projection device 200 in FIG. 1A, the projection device 200 also achieves the effects and advantages, and the descriptions thereof are omitted herein.

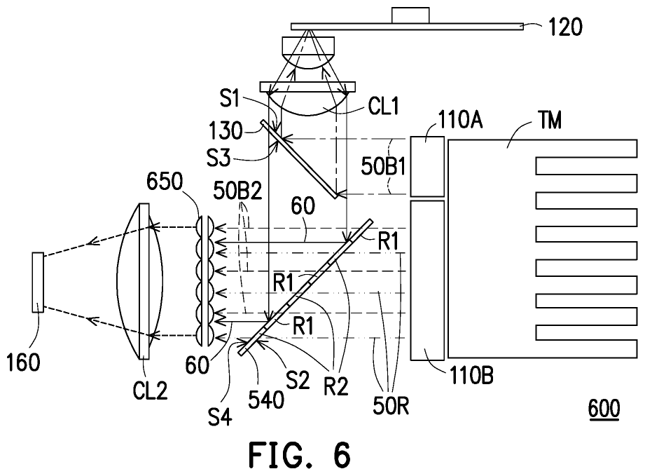

FIG. 6 is a structural schematic diagram of yet another lighting system according to an embodiment of the present invention. Referring to FIG. 6, a lighting system 600 in FIG. 6 is similar to the lighting system 500 in FIG. 5A, but the difference is described as follows. Specifically speaking, as shown in FIG. 6, in the present embodiment, a light homogenization component 650 of the lighting system 600 includes a flyeye or a lens array, the light homogenization component 650 is located between the second light splitting unit 540 and the condensing lens CL2, and the lens array of the light homogenization component 650 is arranged to correspond to the plurality of first regions R1 and the plurality of second regions R2 of the second light splitting unit 540 and homogenizes the passing second laser beam 50B2 and third laser beam 50R. The uniformity of the beams is controlled by controlling the length of the integral column when the light homogenization component includes the integral column, while the angle and uniformity of the passing beams are controlled by controlling the density of the lens array when the light homogenization component includes the lens array. Therefore, the kind of the light homogenization component is selected as required by those with ordinary skill in the art to ensure that the lighting beam of the lighting system achieves the expected performance to meet demands of different products.

In addition, the structures of the first laser source module 110A, the second laser source module 110B, the first light splitting unit 130 and the second light splitting unit 540 of the lighting system 600 are the same as those of the lighting system 500 in FIG. 5. Therefore, the lighting system 600 also achieves the effects and advantages similar to those of the lighting system 500, and the descriptions thereof are omitted herein. In addition, when the lighting system 600 is applied to the projection device 200 in FIG. 1A, the projection device 200 also achieves the above-mentioned effects and advantages, and the descriptions thereof are omitted herein.

Based on the above, the embodiments of the present invention at least have one of the following advantages or effects. In the embodiments of the present invention, due to the design of an optical path that the first laser beam, the second laser beam and the third laser beam are respectively emitted from the first laser source module and the second laser source module in the same direction in the projection device and the lighting system, the first laser source module and the second laser source module are arranged on the same plane, and thus, the projection device and the lighting system achieve a small size and a simple optical path design. In addition, due to the substantial non-parallel arrangement of the first light splitting unit and the second light splitting unit in the projection device and the lighting system, the light collecting efficiency of the excited beam, the second laser beam and the third laser beam achieves good performance, and furthermore, the lighting beam has good color performance.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

What is claimed is:

1. A lighting system, used for providing a lighting beam, comprising a first laser source module, a second laser source module, a wavelength conversion module, a first light splitting unit and a second light splitting unit, wherein
the first laser source module is used for providing a first laser beam, wherein the first laser beam is emitted from the first laser source module along a first direction;
the second laser source module is used for providing a second laser beam and a third laser beam, wherein the second laser beam and the third laser beam are emitted from the second laser source module along the first direction;
the wavelength conversion module is located on a transfer path of the first laser beam;
the first light splitting unit is located on a transfer path of the first laser beam, wherein the first laser beam is transferred to the wavelength conversion module by the first light splitting unit and is converted into an excited beam by the wavelength conversion module; and
the second light splitting unit is located on a transfer path of the second laser beam and the third laser beam, wherein the first light splitting unit and the second light splitting unit are substantially non-parallel, and the excited beam, the second laser beam and the third laser beam form the lighting beam by one of the first light splitting unit and the second light splitting unit.

2. The lighting system according to claim 1, wherein the first laser source module and the second laser source module are located on a same plane.

3. The lighting system according to claim 1, wherein the first light splitting unit is provided with a first surface facing the first laser source module, the second light splitting unit is provided with a second surface facing the second laser source module, and a range of an included angle between the first surface and the second surface is larger than 70° and is smaller than 110°.

4. The lighting system according to claim 1, wherein the second light splitting unit is provided with a first region and a second region which are not overlapped, the second laser beam is irradiated on the first region, while the third laser beam is irradiated on the second region, and a wavelength of the second laser beam is different from a wavelength of the third laser beam.

5. The lighting system according to claim 4, wherein the first laser source module and the second laser source module are arranged along a second direction, and the second direction is substantially vertical to the first direction.

6. The lighting system according to claim 5, wherein the second laser source module comprises a second laser component and a third laser component, the second laser component is used for emitting the second laser beam, the third laser component is used for emitting the third laser beam, the second laser component and the third laser component are arranged along the second direction, and the first region and the second region are arranged along the second direction.

7. The lighting system according to claim 5, wherein the second laser source module comprises a second laser component and a third laser component, the second laser component is used for emitting the second laser beam, the third laser component is used for emitting the third laser beam, the second laser component and the third laser component are arranged along a third direction, the first region and the second region are arranged along the third direction, and the first direction, the second direction and the third direction are vertical to one another.

8. The lighting system according to claim 4, wherein the first laser source module comprises a plurality of first laser components, the second laser source module comprises a plurality of second laser components and a plurality of third laser components, the plurality of first laser components are used for emitting the first laser beam, the plurality of second laser components are used for emitting the second laser beam, the plurality of third laser components are used for emitting the third laser beam, the plurality of second laser components and the plurality of third laser components are staggered, and the second light splitting unit is provided with a plurality of the first regions and a plurality of the second regions, wherein one of the first regions is located between two of the second regions.

9. The lighting system according to claim 1, wherein a dominant wavelength of the first laser beam is smaller than a dominant wavelength of the second laser beam and a dominant wavelength of the third laser beam.

10. The lighting system according to claim 1, wherein the first laser beam and the second laser beam are lights with a same color and different spectrums.

11. The lighting system according to claim 1, further comprising:
a condensing lens, located on a transfer path of the excited beam, the second laser beam and the third laser beam, wherein the second laser beam and the third laser beam are respectively incident into the condensing lens from two sides of a central axis of the condensing lens.

12. The lighting system according to claim 1, further comprising:
a heat radiation module, connected with the first laser source module and the second laser source module.

13. The lighting system according to claim 1, wherein the wavelength conversion module is provided with an annular wavelength conversion layer and is not located on a transfer path of the second laser beam and the third laser beam.

14. A projection device, comprising a lighting system, a light valve and a projection lens, wherein
the lighting system is used for providing a lighting beam and comprises a first laser source module, a second laser source module, a wavelength conversion module, a first light splitting unit and a second light splitting unit, wherein
the first laser source module is used for providing a first laser beam, wherein the first laser beam is emitted from the first laser source module along a first direction;
the second laser source module is used for providing a second laser beam and a third laser beam, wherein the second laser beam and the third laser beam are emitted from the second laser source module along the first direction;
the wavelength conversion module is located on a transfer path of the first laser beam;
the first light splitting unit is located on a transfer path of the first laser beam, wherein the first laser beam is transferred to the wavelength conversion module by the first light splitting unit and is converted into an excited beam by the wavelength conversion module; and
the second light splitting unit is located on a transfer path of the second laser beam and the third laser beam, wherein the first light splitting unit and the second light splitting unit are substantially non-parallel, and the excited beam, the second laser beam and the third laser beam form the lighting beam by one of the first light splitting unit and the second light splitting unit;
the light valve is arranged on a transfer path of the lighting beam and is used for converting the lighting beam into an image beam; and
the projection lens is arranged on a transfer path of the image beam and is used for projecting the image beam out of the projection device.

15. The projection device according to claim 14, wherein the first laser source module and the second laser source module are located on a same plane.

16. The projection device according to claim 14, wherein the first light splitting unit is provided with a first surface facing the first laser source module, the second light splitting unit is provided with a second surface facing the second laser source module, and a range of an included angle between the first surface and the second surface is larger than 70° and is smaller than 110°.

17. The projection device according to claim 14, wherein the second light splitting unit is provided with a first region and a second region which are not overlapped, the second laser beam is irradiated on the first region, while the third laser beam is irradiated on the second region, and a wavelength of the second laser beam is different from a wavelength of the third laser beam.

18. The projection device according to claim 17, wherein the first laser source module and the second laser source module are arranged along a second direction, and the second direction is substantially vertical to the first direction.

19. The projection device according to claim 18, wherein the second laser source module comprises a second laser component and a third laser component, the second laser component is used for emitting the second laser beam, the third laser component is used for emitting the third laser beam, the second laser component and the third laser component are arranged along the second direction, and the first region and the second region are arranged along the second direction.

20. The projection device according to claim 18, wherein the second laser source module comprises a second laser component and a third laser component, the second laser component is used for emitting the second laser beam, the third laser component is used for emitting the third laser beam, the second laser component and the third laser component are arranged along a third direction, the first region and the second region are arranged along the third direction, and the first direction, the second direction and the third direction are vertical to one another.

21. The projection device according to claim 17, wherein the first laser source module comprises a plurality of first laser components, the second laser source module comprises a plurality of second laser components and a plurality of third laser components, the plurality of first laser components are used for emitting the first laser beam, the plurality of second laser components are used for emitting the second laser beam, the plurality of third laser components are used for emitting the third laser beam, the plurality of second laser components and the plurality of third laser components are staggered, and the second light splitting unit is provided with a plurality of the first regions and a plurality of the second regions, wherein one of the first regions is located between two of the second regions.

22. The projection device according to claim 14, wherein a dominant wavelength of the first laser beam is smaller than a dominant wavelength of the second laser beam and a dominant wavelength of the third laser beam.

23. The projection device according to claim 14, wherein the first laser beam and the second laser beam are lights with a same color and different spectrums.

24. The projection device according to claim 14, further comprising:
a condensing lens, located on a transfer path of the excited beam, the second laser beam and the third laser beam, wherein the second laser beam and the third laser beam are respectively incident into the condensing lens from two sides of a central axis of the condensing lens.

25. The projection device according to claim 14, wherein the lighting system further comprises:
a heat radiation module, connected with the first laser source module and the second laser source module.

26. The projection device according to claim 14, wherein the wavelength conversion module is provided with an annular wavelength conversion layer and is not located on a transfer path of the second laser beam and the third laser beam.
